(19) United States
(12) Patent Application Publication
(10) Pub. No.: US 2026/0206819 A1
(43) Pub. Date: Jul. 23, 2026

(54) METHOD OF COMBINED CURING OF TOBACCO LEAVES WITH HOT AIR AND HIGH-VOLTAGE ELECTRIC FIELD

(71) Applicants: Henan Agricultural University, Zhengzhou (CN); China Tobacco Henan Industrial Co., Ltd., Zhengzhou (CN)

(72) Inventors: Jian’an WANG, Zhengzhou (CN); Weidong DUAN, Zhengzhou (CN); Hongtao SHEN, Zhengzhou (CN); Yongfeng YANG, Zhengzhou (CN); Zhaopeng SONG, Zhengzhou (CN)

(21) Appl. No.: 19/031,169

(22) Filed: Jan. 17, 2025

(51) Int. Cl. A24B 3/12; F26B 3/04; F26B 7/00; F26B 21/10

(52) U.S. Cl. CPC A24B 3/12; F26B 3/04; F26B 7/002; F26B 21/35; F26B 2200/22

(57) ABSTRACT

A method of combined curing of tobacco leaves with hot air and high-voltage electric field including installing an ionic wind generator in a tobacco loading chamber of a conventional tobacco curing room, to yield a modified tobacco curing room; presetting curing parameters of the tobacco curing room according to existing curing process parameters; placing fresh tobacco leaves into the tobacco curing room, debugging the high-voltage power source before curing, setting required voltages for each part, and turning off the high-voltage power source after confirming that the tobacco curing room is ready for use; controlling, by the control panel, the operation of the tobacco curing room; turning on the high-voltage power source at the end of a stable temperature curing stage at 38° C., allowing the fresh tobacco leaves to be cured under preset curing parameters; and collecting cured tobacco leaves.

### BACKGROUND

The disclosure relates to the field of tobacco curing, and more particularly to a method of combined curing of tobacco leaves with hot air and high-voltage electric field.

Under the action of high voltage, gases undergo collision ionization to produce charged particles. The charged particles are accelerated under the action of an electric field and exchange momentum with air molecules through collision. The fluid motion exhibited macroscopically is called ion wind. Water evaporates more rapidly under a high-voltage electric field, accompanied by lower energy consumption. This provides theoretical support for drying materials by ion wind. Ionic air drying has the advantages of fast speed and low energy consumption, and the by-products such as ozone produced by air ionization react chemically with the dried material, which has a certain impact on the internal composition and coordination of the dried material.

The high-voltage electric field driven ion wind drying technology has many advantages, but the tobacco curing process is not a simple drying process, chemical changes such as color and aroma substance conversion during the drying process depend on temperature and humidity control in the curing environment. The drying process is significantly different from traditional crop product drying. There is currently a lack of methods to use high-voltage electric fields to drive ion wind to dry tobacco leaves.

### SUMMARY

The disclosure provides a method of combined curing of tobacco leaves with hot air and high-voltage electric field, the method comprising:
1) installing an ionic wind generator in a tobacco loading chamber of a conventional tobacco curing room, to yield a modified tobacco curing room, wherein the ionic wind generator comprises a grounding electrode plate, a pin electrode plate, a high-voltage power source, a control unit, and a control panel; the pin electrode plate is disposed above the tobacco curing room, and a plurality of vertical pin electrodes are uniformly disposed on a bottom of the pin electrode plate; a distance between adjacent two pin electrodes is 20 cm; the pin electrode plate is externally connected to the high-voltage power source and the control unit, and an output voltage of the high-voltage power source is 0-7 kV; the grounding electrode plate is disposed below the tobacco curing room; the control panel comprises a voltage reduction button, a voltage indicator light, a voltage increase button, a high-voltage power indicator light, a high-voltage power fault indicator light, a fan indicator, a fan alarm, and a power switch;
2) presetting curing parameters of the tobacco curing room according to existing curing process parameters;
3) placing fresh tobacco leaves into the tobacco curing room, debugging the high-voltage power source before curing, setting required voltages for each part, and turning off the high-voltage power source after confirming that the tobacco curing room is ready for use;
4) controlling, by the control panel, the operation of the tobacco curing room; turning on the high-voltage power source at the end of a stable temperature curing stage at 38° C., allowing the fresh tobacco leaves to be cured under preset curing parameters; and
5) collecting cured tobacco leaves.

In a class of this embodiment, a distance between the pin electrode plate and the grounding electrode plate is 100-120 cm.

In a class of this embodiment, the output voltage of the high-voltage power source is adjustable, and during a curing process, a voltage value of the high-voltage power source is unchanged.

In a class of this embodiment, a dry basis moisture content and a moisture ratio of the tobacco leaves gradually decrease during the curing process, and a total drying time of the tobacco leaves decreases with the increase of a discharge voltage of the pin electrode.

In a class of this embodiment, the grounding electrode plate, the high-voltage power source, and the control unit are all grounded.

In a class of this embodiment, an electric field is formed by a high voltage at the top of the tobacco leaves to ionize moist air molecules; air ions in a corona zone of the electric field are accelerated by a force applied by the electric field, causing the air molecules to move as a whole and generate ion wind; a steam pressure gradient difference of air between the tobacco loading chamber and the corona zone leads to moisture migration.

In a class of this embodiment, a current voltage of the high-voltage power source is equal to a number of indicator lights on multiplied by 1 kV.

The following advantages are associated with the method of combined curing of tobacco leaves with hot air and high-voltage electric field of the disclosure.

1. The method of combined curing of tobacco leaves with hot air and high-voltage electric field employs a pin-plate high-voltage electric field in the conventional intensive curing environment, which can significantly improve the drying rate of the tobacco leaves of in the process of curing, and increase the effective moisture diffusion coefficient of tobacco leaves. The drying rate and the effective moisture diffusion coefficient are positively correlated with the pin electrode voltage. The method can effectively save labor and energy, improve the quality of tobacco after curing, and increase the economic benefits.

2. The composite drying system of high-voltage electric field and hot air with the ionic wind curing can effectively reduce labor and cost, and significantly enhance the comprehensive income of post-curing tobacco, which is of great significance to improve the industrial availability of post-curing tobacco and increase the income of tobacco farmers. Ionic air generators can be installed on the existing curing rooms, without the need to relearn the operation methods of curing equipment, thus saving the costs, making it easy to quickly popularize in a short period of time.

### BRIEF DESCRIPTION OF THE DRAWINGS

FIG. 1 is a schematic diagram of a modified tobacco curing room in accordance with one embedment of the disclosure;

FIG. 2 shows a distribution diagram of pin electrodes in accordance with one embedment of the disclosure;

FIG. 3 shows a schematic diagram of a control panel in accordance with one embedment of the disclosure;

FIG. 4 shows curing curves used in the embodiments and comparative examples of the disclosure;

FIG. 5 shows curving time and energy consumption in the embodiments and comparative examples of the disclosure;

FIG. 6 shows a comparison table of economic characteristics of cured tobacco in the embodiments and comparative examples of the disclosure;

FIG. 7 shows a comparison table of economic benefits of cured tobacco in the embodiments and comparative examples of the disclosure;

FIG. 8A-8B show changes in dry basis moisture content (FIG. 8A) and moisture ratio (FIG. 8B) of tobacco leaves in the embodiments and comparative examples of the disclosure; and

FIG. 9 shows an effective moisture diffusion coefficient of tobacco leaves in the embodiments and comparative examples of the disclosure.

In the drawings, the following reference numbers are used: 1. Air flow direction; 2. Pin electrode plate; 3. High voltage power source; 4. Control unit; 5. Air inlet; 6. Circulating fan; 7. Corona zone; 8. Carbon crystal electric heating plate; 9. Grounding electrode plate; 11. Voltage reduction button; 12. Voltage indicator light; 13. Voltage increase button; 14. High voltage power indicator light; 15. High voltage power fault indicator light; 16. Fan indicator; 17. Fan alarm; 18. Power switch.

### DETAILED DESCRIPTION

To further illustrate the disclosure, embodiments detailing a method of combined curing of tobacco leaves with hot air and high-voltage electric field are described below. It should be noted that the following embodiments are intended to describe and not to limit the disclosure.

The disclosure provides a method of combined curing of tobacco leaves with hot air and high-voltage electric field, the method comprising:
1) installing an ionic wind generator in a tobacco loading chamber of a conventional tobacco curing room, to yield a modified tobacco curing room, wherein the ionic wind generator comprises a grounding electrode plate 9, a pin electrode plate 2, a high-voltage power source 3, a control unit 4, and a control panel; the pin electrode plate 2 is disposed above the tobacco curing room, and a plurality of vertical pin electrodes are uniformly disposed on a bottom of the pin electrode plate 2; a distance between adjacent two pin electrodes is 20 cm. The potential difference between the two electrodes is equal to the voltage of the pin electrode. An electric field is formed by the high voltage at the top of the tobacco leaves to ionize moist air molecules; air ions in a corona zone of the electric field are accelerated by a force applied by the electric field, causing the air molecules to move as a whole and generate ion wind; a steam pressure gradient difference of air between the tobacco loading chamber and the corona zone leads to moisture migration.

The pin electrode plate 2 is externally connected to the high-voltage power source 3 and the control unit 4, and the output voltage of the high-voltage power source 3 is 0-7 kV. The output voltage of the high-voltage power source 3 is adjustable, and during the curing process, the voltage value of the high-voltage power source 3 is unchanged.

The grounding electrode plate 9 is disposed below the tobacco curing room. Considering the length of the fresh tobacco leaves and the pin electrode, to avoid contact, the distance between the pin electrode plate 2 and the grounding electrode plate 9 is 100-120 cm, and preferably, the distance between the pin electrode plate 2 and the grounding electrode plate 9 is 110 cm. The grounding electrode plate 9, the high-voltage power source 3 and the control unit 4 are all grounded.

The control panel comprises a voltage reduction button 11, a voltage indicator light 12, a voltage increase button 13, a high-voltage power indicator light 14, a high-voltage power fault indicator light 15, a fan indicator 16, a fan alarm 17, and a power switch 18. In the on state of the power switch 18, press the voltage reduction button 11 “−” or voltage increase button 13 “+” can adjust the voltage. The current voltage of the high-voltage power source 3 is equal to the number of indicator lights on multiplied by 1 kV.
2) Presetting curing parameters of the tobacco curing room according to existing curing process parameters;
3) placing fresh tobacco leaves into the tobacco curing room, debugging the high-voltage power source 3 before curing, setting required voltages for each part, and turning off the high-voltage power source after confirming that the tobacco curing room is ready for us;
4) controlling, by the control panel, the operation of the tobacco curing room; turning on the high-voltage power source at the end of a stable temperature curing stage at 38° C., allowing the fresh tobacco leaves to be cured under preset curing parameters; Preferably, the output voltage of the high-voltage power source 3 is 6 kV, and the curing is carried out in accordance with the preset parameters until the end of the curing, and the dry basis moisture content and the moisture ratio of the tobacco leaves gradually decrease during the curing process, and the total drying time of the tobacco leaves decreases with the increase of the discharge voltage of the pin electrode.
5) collecting the cured tobacco leaves.

The dry basis moisture content and the moisture ratio of the tobacco leaves gradually decrease during the curing process, and the total drying time of the tobacco leaves decreases with the increase of the discharge voltage of the pin electrode.

The disclosure is further illustrated by some embodiments and comparison examples as follows.

Anew type airflow rising electric oven (HNND-45 type) designed by Henan Agricultural University is used as a test electric oven, with the internal dimensions of the heating room of 0.50 m×1.35 m×1.40 m, using six carbon crystal electric heating panels as a heat source, with a heating power of 2 kW and a thermal efficiency of 95%. The internal size of the tobacco loading room is 1.40 m×1.35 m×1.40 m, which can load 12-14 clamps of cigarettes, 150-200 kg of fresh tobacco, and 1300-1500 pieces of cigarettes. A curing control instrument is provided to automatically regulate the dry/wet bulb temperature according to the preset curing process curve (FIG. 4).

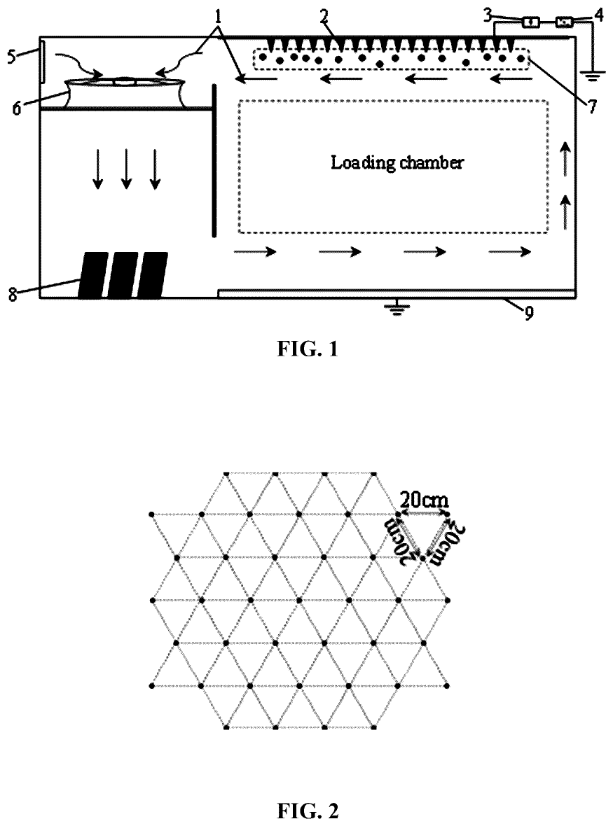

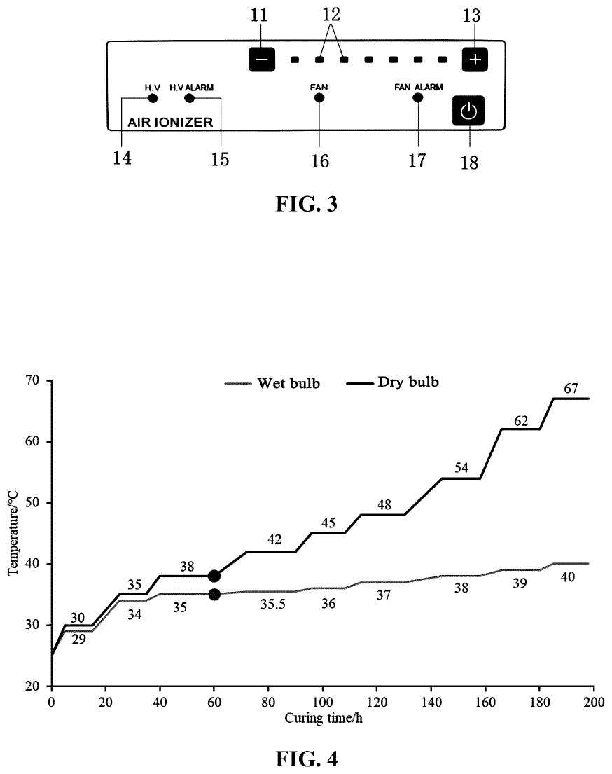

On this basis, an ionized wind generator (as shown in FIG. 1, where: 1, air flow direction; 2, pin electrode plate; 3, high-voltage power source; 4, control unit; 5, air inlet; 6, circulating fan; 7, corona area; 8, carbon crystal electric heating plate; 9, grounding electrode plate) is further installed to form a modified tobacco curing room. The electrodes comprise the grounding electrode plate and the pin electrode plate. The pin electrodes are connected to the high-voltage power source (adjustable from 0-7 kV) and the control unit. Considering the length of the fresh tobacco leaves and the pin electrode, to avoid contact, the distance between the pin electrode plate 2 and the grounding electrode plate 9 is 110 cm. The pin electrodes are disposed as shown in FIG. 2, the distance between adjacent two pin electrodes is 20 cm. The potential difference between the two electrodes is equal to the voltage of the pin electrode. An electric field is formed by the high voltage at the top of the tobacco leaves to ionize moist air molecules; air ions in a corona zone of the electric field are accelerated by a force applied by the electric field, causing the air molecules to move as a whole and generate ion wind; a steam pressure gradient difference of air between the tobacco loading chamber and the corona zone leads to moisture migration.

The equipment used in the comparison embodiment is a new type airflow rising electric oven (HNND-45 type) designed by Henan Agricultural University, which is noted as CK. The equipment used in Example 1 is curing equipment equipped with an ionic wind generator, which is noted as T1, and the voltage of the discharge pin in this scheme is 3 kV; the equipment used in Example 2 is curing equipment equipped with an ionic wind generator, which is noted as T2, and the voltage of the discharge pin is 6 kV.

Normal yellowing and consistent maturity of the middle and upper leaves of the Yunnan tobacco No. 87 were selected as a test material.

Equal amounts of test tobacco were cured using curing equipment CK, T1, and T2, and samples were taken every 12 h from the start of curing, with 6 leaves taken each time from the middle folder near the doorway, and the gap at the sampled leaves was filled with hemp chips. At the end of the 38° C. stabilized temperature stage, the ion fan generator of the T1 and T2 equipment was switched on and timed until the end of the curing process.

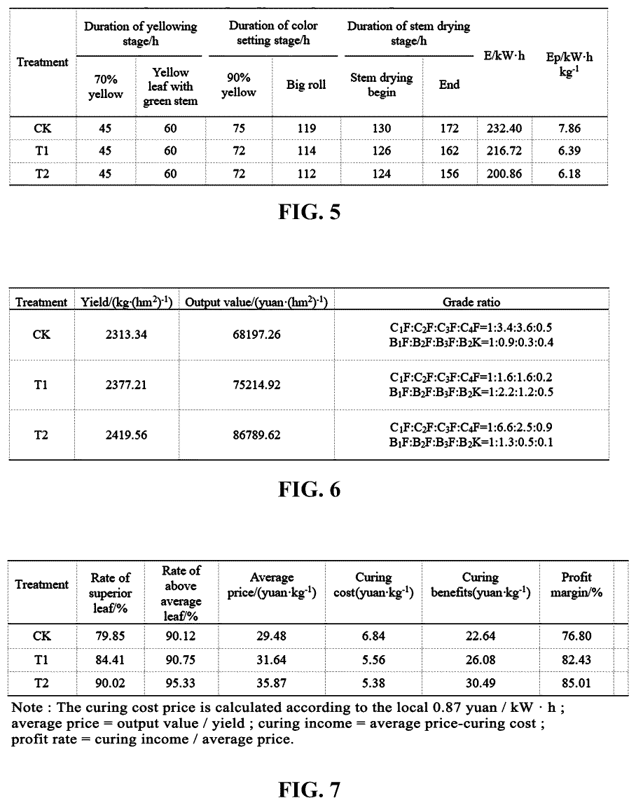

The moisture content, color and energy consumption of the test tobacco leaves were measured and recorded, and a comparison of the energy consumption of different treatments for curing time was obtained, as shown in FIG. 5. As can be seen from FIG. 5, the total curing time of each treatment was T2<T1<CK. Specifically, the curing time in T1, T2 were shortened by 10 h, 16 h respectively compared with the control group. In the yellowing stage, the ionic fan had not yet been involved in the curing, the three time-consuming performance was the same; in the color setting stage, the cumulative time-consuming in T1, T2 were shortened by 5 h, 7 h, respectively, compared to the control equipment. At the end of the yellowing stage, the dry bulb temperature of the oven rose from 38° C. to 42° C. into the color setting stage. The ionic wind generator in the equipment was started, the pin electrodes began to discharge so that the air in the curing environment ionized, increasing the kinetic energy of water molecules within the tobacco leaves, thereby accelerating the migration of internal water out of the tobacco leaves. The late color setting stage to the early stem drying stage (50-55° C.) is a key period of synthesis of aromatic substances in the tobacco, the treatment in the stage was controlled for 10-12 h. In the stem drying stage, CK took 42 h to dry all the tobacco in the oven, which were 6 h and 10 h longer than T1 and T2, respectively. In addition, when T1 and T2 were equipped with ionized wind equipment, the power of the ionized wind equipment was very small relative to the electric oven, along with the shortening of the curing time, the power consumption in the curing process was positively correlated to the length of the curing time, and the total power consumption of T1, T2 was reduced by 6.75%, 13.57% respectively compared with CK. The power consumption per kilogram of dry tobacco leaves decreased by 18.70%, 21.37%, respectively. The above results show that the use of ionic wind in the curing process to assist drying has a certain impact on the curing time, and as the pin electrode voltage of the ionic fan increases, the curing time tends to shorten. The high-voltage electric field acting on water molecules in the curing environment increases their electric field force, accelerates their movement rate, promotes the breaking of hydrogen bonds, and accelerates the dehydration of the main vein during the drying period, effectively shortening the curing time and reducing curing energy consumption.

Comparison of economic traits of cured tobacco leaves under different treatments is shown in FIG. 6, and the comparative analysis in FIG. 6 shows that the yield and production value after different treatments are T2>T1>CK, of which the production value in T2 increased by 27.26% relative to CK, and the yield increased by 4.59%; and the production value in T1 increased by 10.29% compared with CK, and the yield increased by 2.77%. For each treatment of CK, T1 and T2, the total C1F, C2F and C3F grades accounted for 93.91%, 91.99% and 95.29%, respectively, and the total B1F, B2F and B3F grades accounted for 84.42%, 90.05% and 96.77%, respectively. The upper-middle tobacco leaves were all treated in T2 to obtain the highest proportion of high-grade quality tobacco and the least amount of miscellaneous color tobacco. This shows that ionized air curing with appropriate voltage can make the tobacco obtain better grade quality and economic benefits.

According to the purchase price of flue-cured tobacco in the year (second pricing area, Yunnan Tobacco No. 87 varieties) and grading standards, the curing benefit of this experiment was calculated as shown in FIG. 7, which shows that all indicators except curing cost showed a sequential increasing trend in the order of CK, T1, T2, and vice versa for curing cost. Among them, the proportion of top-grade tobacco in T1 and T2 was 4.56 and 10.17 percentage points higher than CK, and the proportion of middle- and top-grade tobacco in T2 was 5.21 percentage points higher than that in CK. According to the quotient of output value and yield of different treatments to get the average price, the treatments of T1 and T2 with ionic wind curing were raised by 2.16 yuan/kg and 6.39 yuan/kg compared with the control group, respectively; and the curing benefit of the two treatments with ionic wind was raised by 3.44 yuan/kg compared with the control group, respectively. The curing revenue of two treatments with ionic wind was increased by 3.44 yuan/kg and 7.85 yuan/kg respectively compared with the control group, and the profit margin was increased by 5.63 and 8.21 percentage points respectively compared with the control group; combining the curing time and energy consumption of each treatment, it can be seen that the curing cost of T1 and T2 was saved by 1.28 and 1.48 yuan/kg respectively compared with that of CK, and the cost of ionic wind curing was still lower than that of traditional hot-air curing. It can be seen that the composite drying system of high-voltage electric field and hot air with the ionic wind curing can effectively reduce labor and cost, and significantly enhance the comprehensive income of post-curing tobacco, which is of great significance to improve the industrial availability of post-curing tobacco and increase the income of tobacco farmers.

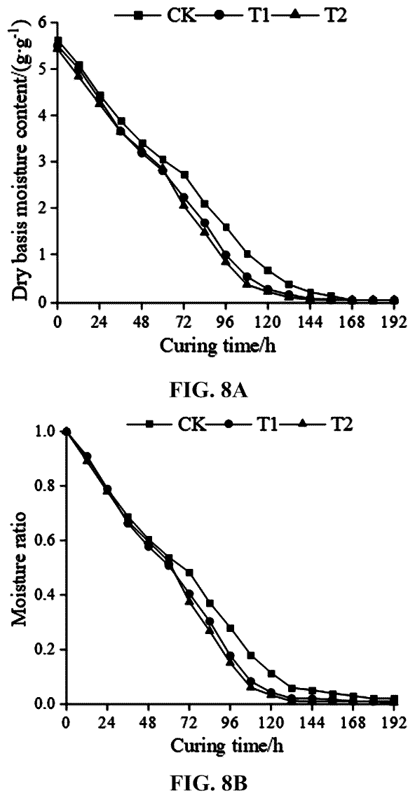

The drying characteristics of Yunnan tobacco No. 87 under different voltages are shown in FIGS. 8A-8B. From FIG. 8A and FIG. 8B, it can be seen that the dry basis moisture content and moisture ratio of tobacco decreased gradually during the curing process, and the total time required for drying decreased with the increase of the voltage of the discharge pin, and the trend of the two was the same. The difference between the moisture ratio of the three treatments and the dry basis moisture content was relatively small before 60 h. The trend of the change of the dry basis moisture content and the moisture ratio between the control group and the treatments appeared to be obviously different after 60 h. The drying of CK, T1 and T2 was balanced at 168 h, 156 h and 144 h, respectively. This is because a strong electric field was applied to the traditional hot air-drying system, the point discharge of the pin electrodes led to the formation of the ionic wind. As the voltage increased, the amount of ionic air generated also increased, which played two roles in the outward diffusion of moisture inside the tobacco leaves. Firstly, the deposition of charged particles on the surface of the tobacco leaves increased the thermal conductivity rate of the tobacco leaves. Secondly, the surface and internal water molecules of the tobacco leaves absorbed the energy carried by air ions, leading to an increase in kinetic energy and accelerating the loss of moisture from the tobacco leaves. This significantly improves the drying speed and shortens the curing time.

The drying rate curves of Yunnan Tobacco No. 87 under different voltages are shown in FIGS. 8A-8B, with the increase of discharge voltage, the drying rate of tobacco with the same dry basis moisture content also increased. CK showed an early rising and then falling in the stage of dry basis moisture content from 1.2 to 2.4 g/g. The drying rate of T1 and T2 in the stage of dry basis moisture content from 2.4 to 3.1 g/g rose again, and the rising rate of CK was obviously lower. At the later stage, the dry basis water content declined from 1.5 g/g, the drying rate of the two treatments under the same dry basis water content was still higher than the control group, but the gap therebetween was gradually narrowed.

By plotting the scatter plot of ln(MR)-t during the curing process of the three treatments, CK, T1 and T2, and then by linear fitting, a linear regression equation can be derived for the three treatments of tobacco ln(MR) versus the curing time t. The effective moisture diffusion coefficient of the tobacco leaves is calculated according to the formula

$$InMr = In ( \frac{8}{{π}^{2}} ) - \frac{{π}^{2} {D}_{eff}}{{L}^{2}} t and {k}_{0} = \frac{{π}^{2} {D}_{eff}}{{L}^{2}}$$

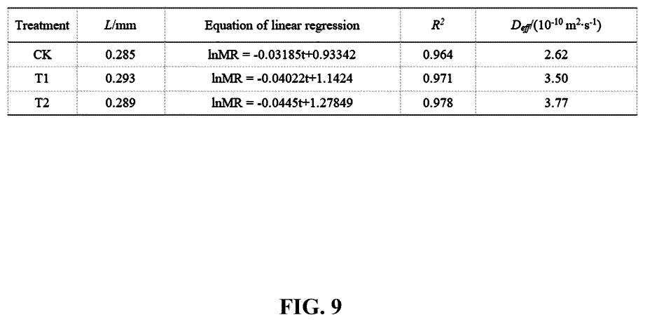

(where: L is an average thickness of the tobacco in the drying process, unit: m; and t is a duration of the curing time, unit: h), as shown in FIG. 9. It can be seen that the effective moisture diffusion coefficient of tobacco in the roasting process increased from 2.62×10⁻¹⁰ m²/s to 3.77×10⁻¹⁰ m²/s when the voltage of the ion blower discharge pin was increased from 0 kV to 6 kV, which indicates that the ion wind generated by the appropriate pin electrode voltage can effectively increase the effective moisture diffusion coefficient of the tobacco in the roasting process.

In summary, the assembly of pin-plate high-voltage electric field in the conventional intensive curing environment can significantly improve the drying rate of the upper leaves of Yunnan tobacco No. 87 in the process of curing, increase the effective moisture diffusion coefficient of tobacco, which are positively correlated with the pin electrode voltage. The drying rate is the fastest when the pin electrode voltage is 6 kV, and the value D_{eff} is the largest.

It will be obvious to those skilled in the art that changes and modifications may be made, and therefore, the aim in the appended claims is to cover all such changes and modifications.

What is claimed is:

1. A method of combined curing of tobacco leaves with hot air and high-voltage electric field, the method comprising:
1) installing an ionic wind generator in a tobacco loading chamber of a conventional tobacco curing room, to yield a modified tobacco curing room, wherein the ionic wind generator comprises a grounding electrode plate, a pin electrode plate, a high-voltage power source, a control unit, and a control panel; the pin electrode plate is disposed above the tobacco curing room, and a plurality of vertical pin electrodes are uniformly disposed on a bottom of the pin electrode plate; a distance between adjacent two pin electrodes is 20 cm; the pin electrode plate is externally connected to the high-voltage power source and the control unit, and an output voltage of the high-voltage power source is 0-7 kV; the grounding electrode plate is disposed below the tobacco curing room; the control panel comprises a voltage reduction button, a voltage indicator light, a voltage increase button, a high-voltage power indicator light, a high-voltage power fault indicator light, a fan indicator, a fan alarm, and a power switch;
2) presetting curing parameters of the tobacco curing room according to existing curing process parameters;
3) placing fresh tobacco leaves into the tobacco curing room, debugging the high-voltage power source before curing, setting required voltages for each part, and turning off the high-voltage power source after confirming that the tobacco curing room is ready for use;
4) controlling, by the control panel, the operation of the tobacco curing room; turning on the high-voltage power source at the end of a stable temperature curing stage at 38° C., allowing the fresh tobacco leaves to be cured under preset curing parameters; and
5) collecting cured tobacco leaves.

2. The method of claim 1, wherein a distance between the pin electrode plate and the grounding electrode plate is 100-120 cm.

3. The method of claim 1, wherein the output voltage of the high-voltage power source is adjustable, and during a curing process, a voltage value of the high-voltage power source is unchanged.

4. The method of claim 1, wherein a dry basis moisture content and a moisture ratio of the tobacco leaves gradually decrease during the curing process, and a total drying time of the tobacco leaves decreases with the increase of a discharge voltage of the pin electrode.

5. The method of claim 1, wherein the grounding electrode plate, the high-voltage power source, and the control unit are all grounded.

6. The method of claim 1, wherein an electric field is formed by a high voltage at the top of the tobacco leaves to ionize moist air molecules; air ions in a corona zone of the electric field are accelerated by a force applied by the electric field, causing the air molecules to move as a whole and generate ion wind; a steam pressure gradient difference of air between the tobacco loading chamber and the corona zone leads to moisture migration.

7. The method of claim 5, wherein a current voltage of the high-voltage power source is equal to a number of indicator lights on multiplied by 1 kV.
